(19) United States
(12) Patent Application Publication
(10) Pub. No.: US 2005/0230592 A1
(43) Pub. Date: Oct. 20, 2005

(54) Automated page turner

(76) Inventors: Adam Corey Tillinghast, Chepachet, RI (US); Nevan Clancy Hanumara, Kingston, RI (US); Ellaine Marcelino Abueg, Troy, NY (US); John James Coughlin, North Kingstown, RI (US); Terence Francis Malaghan, Westerly, RI (US); Oliver Koenig, Euskirchen (DE); Musa K. Jouaneh, Wakefield, RI (US); Robert A. Comerford, Wakefield, RI (US); Ying Sun, Wakefield, RI (US)

Correspondence Address: ADAM TILLINGHAST, 446 CHESTNUT HILL RD, CHEPACHET, RI, 02814, US

(21) Appl. No.: 11/108,210

(22) Filed: Apr. 18, 2005

Related U.S. Application Data
(60) Provisional application No. 60/563,381, filed on Apr. 19, 2004.

(51) Int. Cl. B42D 3/00

(52) U.S. Cl. 248/441.1

(57) ABSTRACT

An automated page turner apparatus for turning the pages of a book either forwards or backwards under the control of a single-switch input. It comprises of a base for book support, a clutch based mechanism for lifting a page with an adhesive head, a shifting mechanism for flipping a page to the opposite side, and an electronic controller for receiving the user input. The lifting mechanism includes a four-bar system for creating a peeling action to separate the adhesive head from the lifted page.

### CROSS-REFERENCES TO RELATED APLICATIONS

U.S. Patent Publications

U.S. Pat. No. 4,644,675: J. G. Berger and D. J. Emmons, Feb. 24, 1987 Page Turning Device

U.S. Pat. No. 4,780,977: J. M. Howard and C. Tsoucalas, Nov. 1, 1988 Page Turning Apparatus

U.S. Pat. No. 6,049,033: W. G. Dallas, Apr. 11, 2000 Page Turning Device

### PRIORITY DATA

This application claims the benefit of U.S. Provisional Application No. 60/563,381, filed Apr. 19, 2004, and hereby incorporated by reference.

### BACKGROUND OF THE INVENTION

The field of use for this invention is mainly in but not limited to assistive technology for aiding persons with disabilities. Based on recent Federal census statistics it is estimated that 28 million Americans (9.6%) have severe disabilities and another 29 million Americans (9.9%) have minor disabilities. During the 20th century the life expectancy in the United States increased from 47 years to 77 years. Presently 41 million Americans (14%) are over the age of 65. As our society ages, assistive technology becomes increasingly important for helping not only people with disabilities but also the elderly. Assistive technology devices help these populations improve their quality of life and independence, which also has an important economic impact on society by reducing costs for care giving.

For many people with disabilities the quality of life is severely hindered by the loss of simple pleasures. These people may have limited mobility because of conditions such as quadriplegia, paraplegia, cerebral palsy, severe arthritis, spinal cord injury, head injury, and other neuromuscular disorders. For people with impeded upper body dexterity, it may be possible to accomplish such gross tasks as driving a vehicle, but a seemingly simple and universally pleasurable task, reading books, presents a significant challenge. Many current designs attempt to address too many scenarios with one overcomplicated and/or failure prone device. In fact, those intended for leisure reading would seem more appropriate for “industrial applications” such as digitizing books. Most people with severe or even moderately severe disabilities are often surrounded by intrusive technological aids. So there is a need for a simple, non-intrusive, affordable and reliable device that allows the user to focus on the intended activity; reading the book. This issue has been widely addressed with varying levels of success.

There are three prior arts in particular that stand out amongst the tens of “page turner” patents that have been developed. But while all three designs show promise initially, closer inspection reveals key weaknesses for development in the field of assistive technology. U.S. Pat. No. 4,644,675 “Page Turning Device” incorporates a spring-loaded rubber roller, which rests on the edge of a book. When activated the roller pushes a page towards the spine, causing a loop to form. A “finger like” cam then hooks under this loop and as it rotates it flips the page. One major issue with this design is the fact that it is unidirectional. Imagine the frustration of reading or perusing a book and never being able to turn a page backwards. The other major issue with this design is one that is common with a large percentage of both patented and commercially available devices; utilizing some sort of friction member to separate individual pages. In this case it is the rubber roller. Devices that employ rollers, wipers, or similar actions as a means of separating individual pages rely mostly on the frictional force generated between the separator and the page to be turned. But these actions initiate frictional forces between the pages themselves that resist page separation. The coefficient of friction between individual pages of a book can vary greatly from book to book due to large differences in paper glossiness, type of ink and type of paper. This will always be an issue unless forces applied to the pages are almost entirely normal to the page.

U.S. Pat. No. 6,049,033 “Page Turning Device” faces this same issue but in a somewhat different way. This device employs a springy finger with a rubber tip mounted on an axis above and parallel to the book's spine. As the finger is rotated in either direction the rubber tip contacts the page and the finger bends. As rotation continues the leaf is swiped from one side to the other of the book. In addition to the issue previously mentioned, this mechanism also has the potential to be rough with the pages, possibly folding or tearing them. And the nature of the design does not allow it to compensate for changes in thickness of the remaining pages of a book, as the forces applied will vary greatly from beginning to end.

U.S. Pat. No. 4,780,977 “Page Turning Apparatus” takes a very different design approach and employs an articulating vacuum head to lift the page and a separate mechanical arm to turn it. While the design utilizes forces normal to the page to separate it from the next page it has its own weaknesses. Four electric motors are used and the device is relatively cumbersome and intrusive. The vacuum has the potential to be quite loud and studies have shown that it is relatively difficult calibrate such that only a single page is lifted.

In response to the market need and with careful consideration given to the design progress and weaknesses previously discussed a novel, simplistic, reliable and affordable page turner device has been developed. This design employs a renewable/reusable adhesive and a mechanically simple peeling action that combine to form a very gentle means of separating individual pages effectively across a broad spectrum of page types, glossiness, and inks. This non-intrusive design is able to turn single pages in either direction and is designed to function with any sort of single or double switch mechanism. This versatility makes the device accessible to anyone who can only furrow an eyebrow, move a finger, or sip-and-puff tube.

The preliminary result from an earlier prototype of the automated page turner showed that the size and strength of the adhesive might become a potential problem. On the one hand, a weak adhesive contact may not be sufficient to lift the page up. On the other hand, a strong adhesive contact that can reliably lift the page may fail to release the page in the final step of page separation. This problem has been resolved in an improved prototype. The essence of this invention is the combination of an adhesive lifting mechanism and a four-bar mechanical design that creates a peeling action for page separation. The design takes advantage of the fact that the bonding between the adhesive and the page is weak in peeling but strong in the normal direction. The strength in the normal direction ensures that the page will be consistently lifted, while a peeling action helps the separation of the adhesive from the page. The invention leads to an effective and relatively simple design of automated page turner that can turn pages in both forward and backward directions.

### SUMMARY OF THE INVENTION

The invention is an automated page turner with mechanisms for lifting and shifting individual pages. The lifting mechanism rotates 180 degrees in an arc motion in order to adhere the page. The lifting mechanism includes a four-bar system (primary arm, secondary arm, link arm, and adhesive head) that creates a peeling action for helping the separation of the lifted page from the adhesive head. The shifting mechanism moves horizontally in order to catch a single lifted page, separate it from the adhesive head, and flip it to the opposite side. These components as well as a clamping mechanism that secures the book are supported by a base. This base can be placed horizontally or at an angle, using the adjustable leg underneath the base. A microprocessor-based controller receives single switch input from the user and activates the two motors of the lifting and shifting mechanisms.

In one aspect, the invention utilizes a washable, re-usable adhesive such as BIC ReStick™. This adhesive is placed underneath the adhesive head for lifting a page up. The adhesive head lands on a page with adequate pressure applied via a clutch system. The adhesive head lifts the page as it rotates upward by the lifting mechanism.

In another aspect, the invention includes bidirectional lifting and shifting mechanisms such that pages can turn in both the forward direction and the backward direction.

In yet another aspect, the lifting mechanism can slide up and down, along the center line of the base. The position of the lifting mechanism is adjustable to accommodate various book heights.

In yet another aspect, the lifting mechanism utilizes a clutch to control the force applied by the adhesive head to the page. This force is consistent, independent of the height of the remaining pages of the book.

In yet another aspect, the invention includes a book clamping device that holds the cover of the book flat on the book support.

This invention further includes an electronic controller, which allows the device to be controlled by a single-switch and coordinates the turning of a page either backwards or forwards. One embodiment might be a sip and puff, i.e. sip for forward and puff for back. A less disabled user could operate two switches, one for each direction.

### BRIEF DESCRIPTION OF THE DRAWINGS

FIG. 1 is a perspective view of an embodiment of the invention without a book inserted;

FIG. 2 is a perspective view of an embodiment of the invention with a book inserted;

FIG. 3 is a perspective view of the lifting mechanism;

FIGS. 4A-4B are perspective views of the lifting mechanism showing the peeling action;

FIG. 5 is a perspective view of the shifting mechanism;

FIG. 6 is a block diagram of the control system including motors and sensors; and

FIG. 7 is a flow chart of the control algorithm.

### DETAILED DESCRIPTION OF THE INVENTION

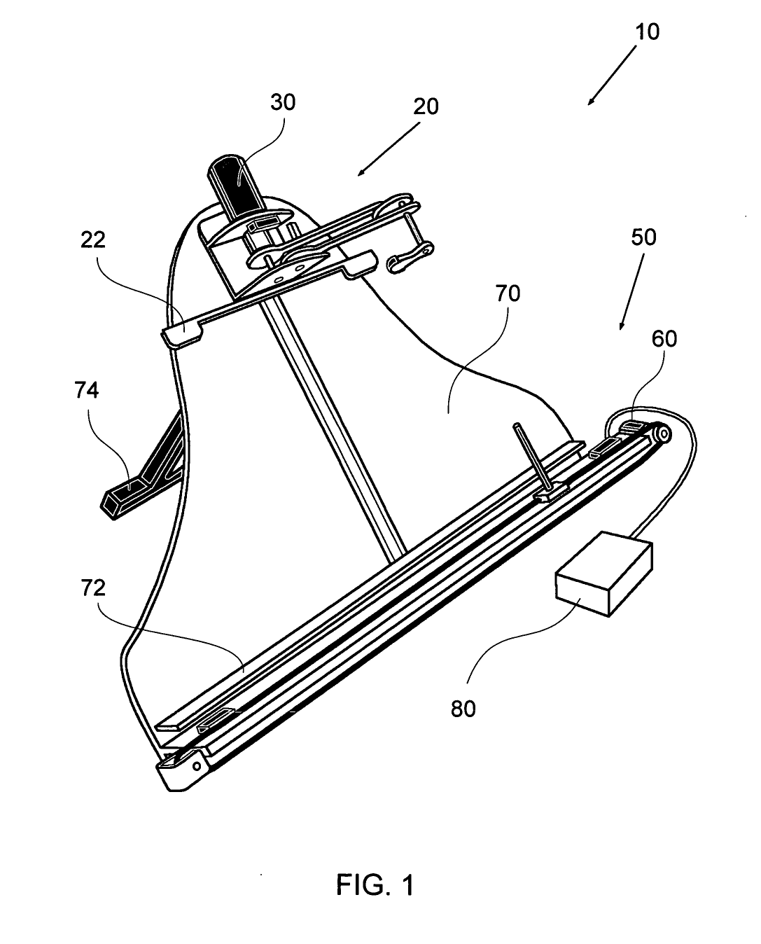

Referring to FIG. 1, the automated page turner device (10) is generally shown. The lifting mechanism (20) is placed at the top of the base (70). The shifting mechanism (50) is attached to the bottom of the base. The book clamp (22) is an integral part of the lifting mechanism (20) and is adjustable to receive the cover of a book (not shown). The ledge (72) is attached near the bottom of the base to support the book. The apparatus is supported by a leg (74) attached to the backside of the base. Other possible means to support the apparatus include a stand, an easel, or a mechanical mounting arm (not shown). The controller (80) is a microprocessor based electronics device that controls the operation of the automated page turner.

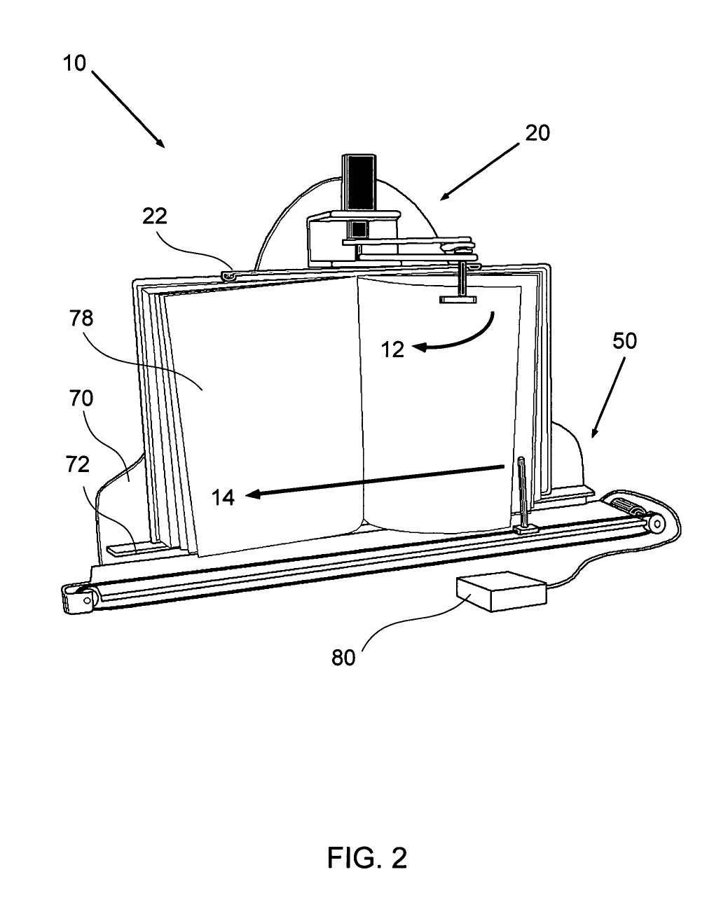

Referring to FIG. 2, a book (78) is placed in the apparatus and the page turning operation is in progress. The book is supported by the base (70), the ledge (72), and the book clip (22). A page is turned in two steps: First, the page is lifted by the lifting mechanism (20) in the direction shown by the arrow (12). Second, the page is shifted to the opposite side by the shifting mechanism (50) in the direction shown by the arrow (14). The page-turning operation is bi-directional such that a page can be turned either forward or backward. The controller (80) takes a single-switch input (not shown) to activate the automated page-turning process, control the timing for lifting and shifting, and toggle the forward/backward direction.

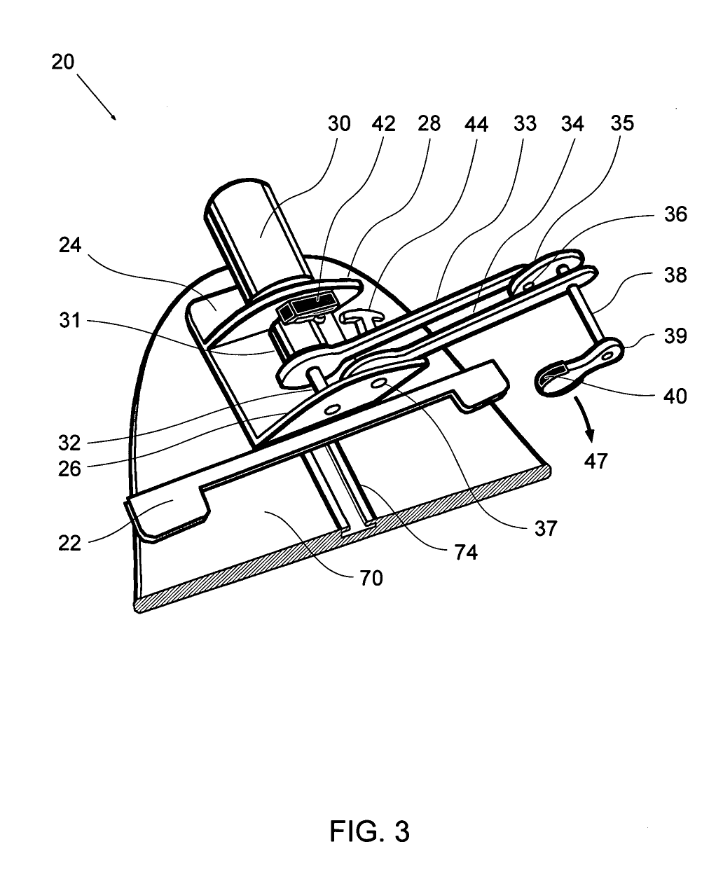

Referring to FIG. 3, the lifting mechanism (20) is generally shown. The purpose of the lifting mechanism is to lift a page up with an adhesive head (38). The lifting mechanism is supported by a carrier plate (24), which can slide along the track (74) on the base (70). This sliding feature allows for adjusting the position of the book clip (22) to accommodate various book sizes. The lifting mechanism (20) is comprised of a face plate (26), motor mount (28), lifting motor (30), clutch (31), motor shaft (32), primary arm (33), secondary arm (34), arm link (35), primary arm shaft (36), secondary arm shaft (37), head shaft (38), adhesive head (39), adhesive (40), position-sensing switch (42), and trigger (44) for the switch. The lifting motor (30), mounted on the motor mount (26), powers the 180-degree range of movement of the primary arm (33) by way of the motor shaft (32). A trigger (44) attached to the primary arm (33) activates a position-sensing switch (42) in either a clockwise rotation or a counter-clockwise rotation. The switch (42) sends a signal to the controller (not shown) when the primary arm (33) is at an up-right position. The controller coordinates the following actions to lift a single page. The lifting motor (30) causes the primary arm (33) to rotate about the motor shaft (32). To turn a page forward, i.e. from right to left, the lifting motor (30) drives the adhesive head (39) down, in the direction shown by the arrow (47), to make the adhesive (40) in contact with the page. Because of the inclusion of the clutch (31) it is possible to power the lifting motor (30) continuously in the same direction for a pre-programmed period of time. This allows the adhesive head (39) to exert consistent force on the page regardless of the thickness of the remaining pages of the book. This clutch based mechanism ensures the page will be lifted up in the subsequent step. To lift and separate the page the lifting motor (30) now reverses the direction of rotation.

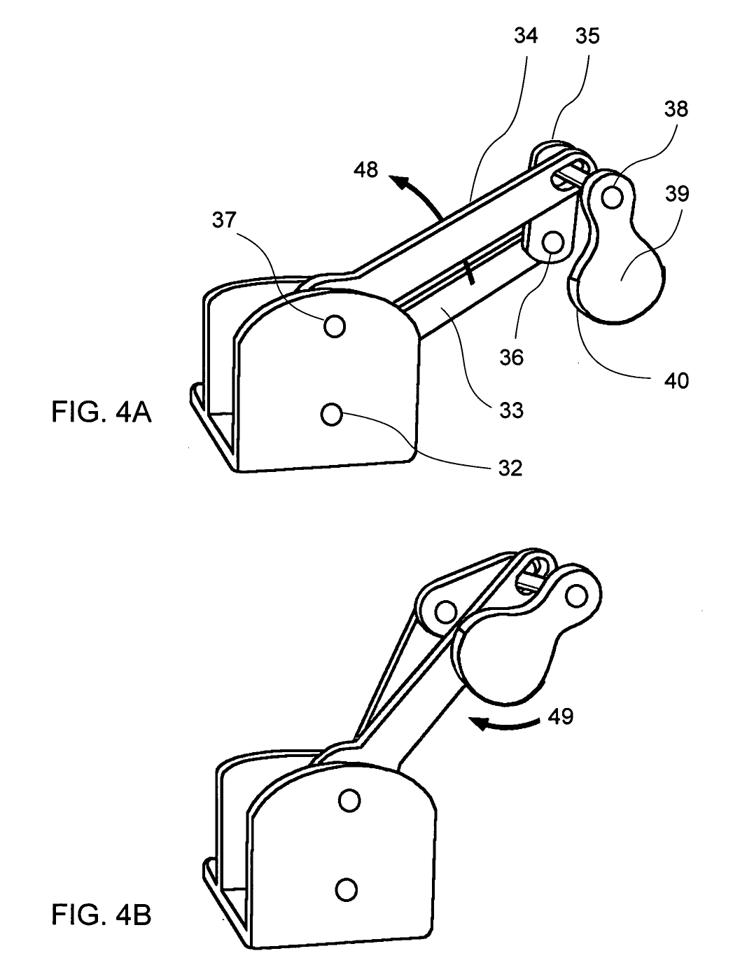

Referring to FIG. 4A, The primary arm (33) rotates in the direction shown by the arrow (48). In turn the primary arm (33) causes the arm link (35) to rotate in the opposite direction, about the secondary arm shaft (37), while still being pulled by the primary arm shaft (36) to rotate about the motor shaft (32) in the same direction as the primary arm (33). The arm link (35) causes the secondary arm (34) to rotate in the same direction as the primary arm (33), about the secondary arm shaft (37), while being pulled by the head shaft (38). The adhesive head (39) is rotationally fixed with respect to the head shaft (38), which is rotationally fixed with respect to the arm link (35). This causes the adhesive head (39) to follow the rotational path of the arm link (35), thus opposing that of the primary arm (33) and secondary arm (34). The page is now lifted up, following the rotation of the primary arm (33). At a certain point of the overall travel of the mechanism the head shaft (38) begins to slide in the slot of the secondary arm (34). This momentarily halts the rotation of the secondary arm (34) while the primary arm (33), arm link (35), and adhesive head (39) continue to rotate in their respective directions. At this point the combination of the arm link (35) and the adhesive head (39) are no longer rotating about the motor shaft (32) and the only rotations of the whole system are the opposing rotations of the combination of the arm link (35) and the adhesive head (39) and the combination of the primary arm (33) and the page. This results in the peeling action of the adhesive head (39), which peels itself from the page. The relative position between the primary arm (33) and secondary arm (34) changes from parallel (FIG. 4A) to crossed (FIG. 4B). This crossing of the two arms occurs suddenly and creates the peeling action of the adhesive head (39). Referring to FIG. 4B, as the adhesive head (39) lifts the page up, the sudden rotation of the adhesive head (39) in the direction shown by the arrow (49) helps the separation of the page from the adhesive (40). The complete separation between the page and the adhesive head (39) is accomplished with the help of the shifting mechanism in the subsequent step.

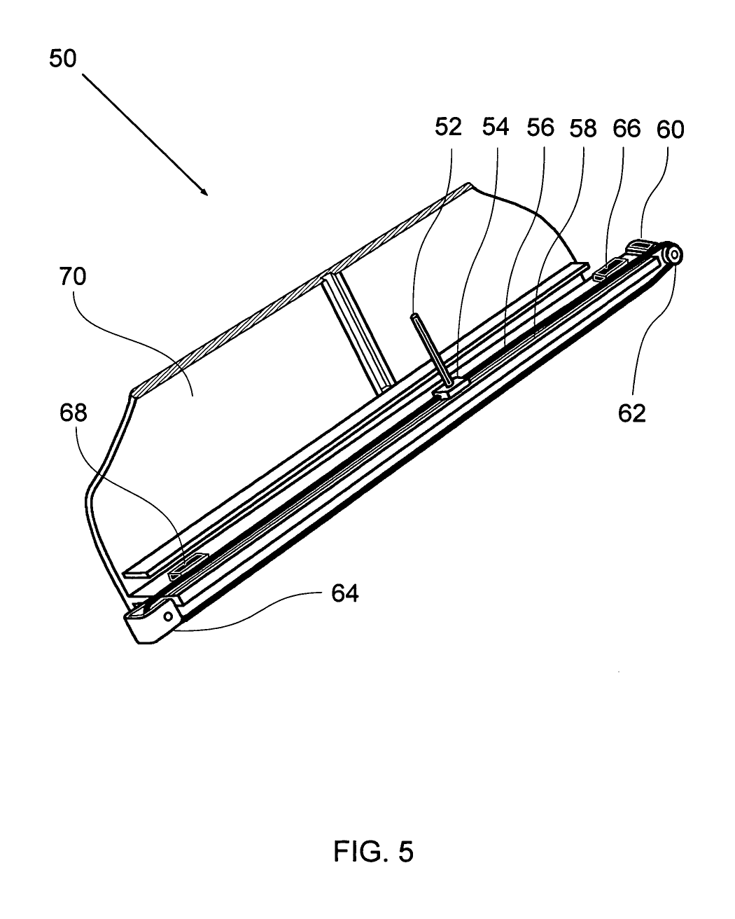

Referring to FIG. 5, the shifting mechanism (50) attached to the bottom of the base (70) is generally shown. The shifting mechanism (50) is comprised of a finger (52), slider (54), timing belt (56), linear track (58), shifting motor (60), right pulley (62), left pulley (64), right limiting switch (66), and left limiting switch (68). Once a page has been lifted, the controller (not shown) then activates the movement of the shifting mechanism (50). The shifting motor (60) can turn in either direction to move the slider (54) along the linear track (58). In turn the finger (52) attached to the slider (54) shifts the page from one side to the other. The slider (54) is pulled by the timing belt (56), which is supported by the right pulley (62) and the left pulley (64). The right pulley (62) is mounted on the shaft of the shifting motor (60). When the slider (54) travels near the left end of the track (58), it triggers the left limiting switch (68). The controller receives the switch signal and stops the shifting motor (60) immediately. Similarly, the right limiting switch (66) is used to stop the slider (54) as it reaches the right end of the track (58).

The base (70) of the page turner device (10) can be made from any sturdy material, such as wood, plastic, and aluminum. Preferably, the base (70) should be comprised of a lightweight, durable plastic such as Lexan™. The carrier plate (24), face-plate (26), and motor mount (28) of the page-lifting mechanism (20) can be made of the same materials as specified for the base (70) or of a less sturdy material, such as plywood. The adhesive (40) can be any re-usable adhesive, such as the adhesive used in BIC ReStick™m.

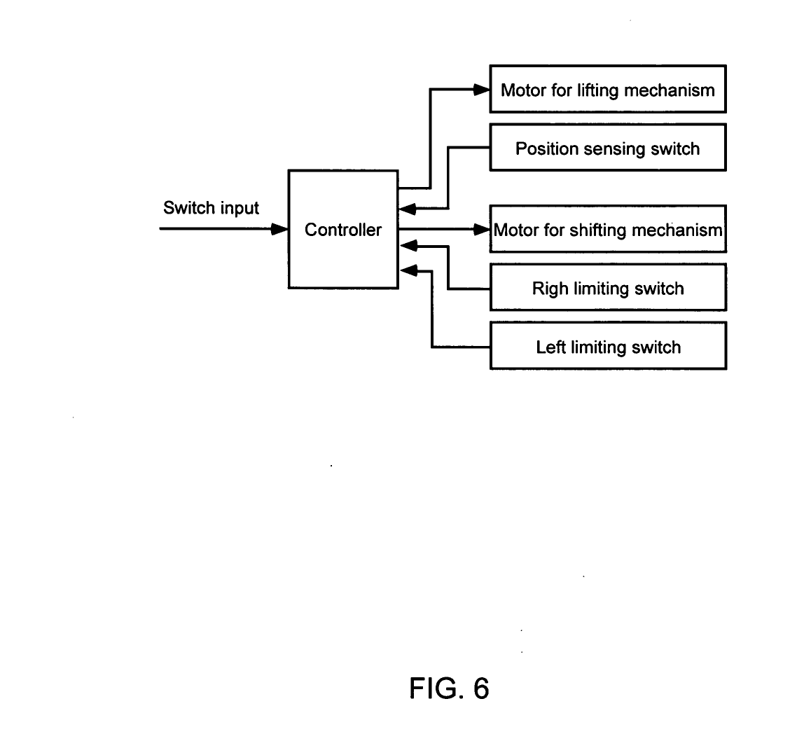

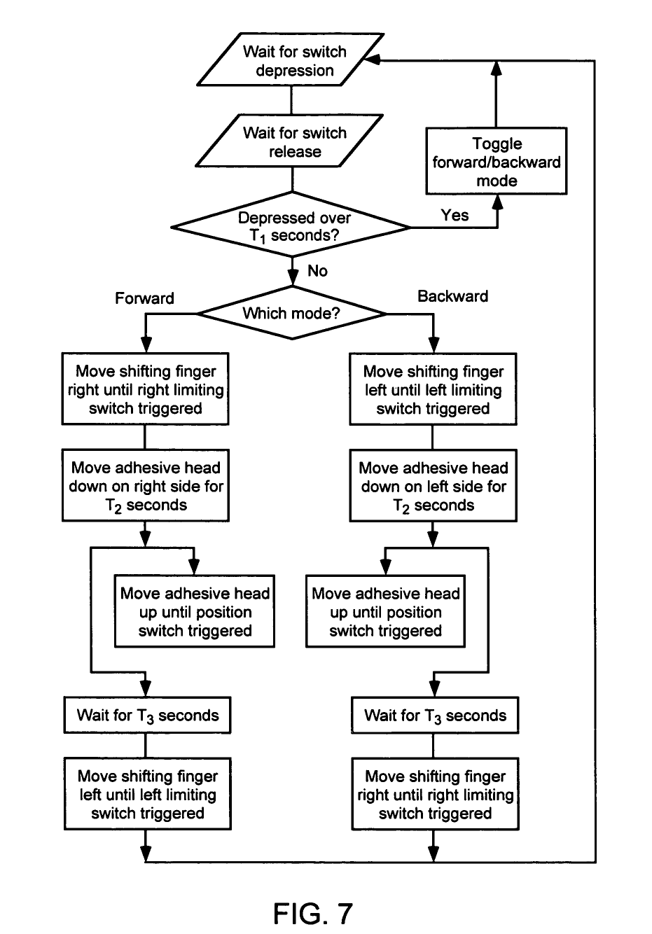

The controller (80) provides the user interface for the page turner device (10). Referring to the block diagram of the controller shown in FIG. 6, the user's input to the controller is a single switch signal. In turn the controller activates the lifting motor and the shifting motor. The controller unit includes a momentary, normally-open, push-button switch. The controller also has an input jack that can receive an external switch signal. This interface is universal for persons with disabilities who can use their own ability switches such as a sip-or-puff switch or a muscle-twist sensor. The controller can differentiate two different actions from the switch: a quick depression and a long depression. The quick depression activates the process of turning one page. The long depression toggles the mode between turning forward and turning backward. The control algorithm can be implemented on a microprocessor. FIG. 7 shows a flow chart of the control algorithm. There are three timing parameters (T₁, T₂, and T₃) that can be adjusted according to the user's response time and the speed of the two motors selected for the page turner. T₁ is the maximum allowable depression duration for a quick depression of the switch. If the depression time is greater than T₁ the switch input is regarded as a long depression. T₂ is the time period of powering the lifting motor to move the adhesive head down onto the page. T₂ is to be programmed according to the speed of the lifting motor. Because of the presence of the clutch, the lifting motor can be allowed to run beyond the initial contact point between the adhesive head and the page. In other words, the exact setting of T₂ is not critical. T₃ is the time period from the onset of page lifting to the onset of page shifting. T₃ is to be programmed according to the speed of the shifting motor and the desirable time for the finger to make the initial contact with the lifted page.

1. An automated page turner apparatus which comprises:
a book support;
a lifting mechanism that lifts an individual page with an adhesive head;
a shifting mechanism that flips the lifted page to the opposite side; and
a controller that receives user input and sequences the page turning process.

2. The apparatus of claim 1 wherein the adhesive head utilizes a renewable and reusable adhesive.

3. The apparatus of claim 1 wherein both the lifting mechanism and the shifting mechanism are bidirectional such that pages can turn in both the forward direction and the backward direction.

4. The apparatus of claim 1 wherein the position of the lifting mechanism is adjustable to accommodate various book heights.

5. The apparatus of claim 1 wherein the lifting mechanism utilizes a clutch to control the force applied by the adhesive head to the page.

6. The apparatus of claim 1 wherein a book clamping device holds the cover of the book flat on the book support.

7. The apparatus of claim 1 wherein the controller receives user input from a single switch.

8. An automated page turner apparatus which comprises:
a book support;
a controller that receives user input and sequences the page turning process;
a shifting mechanism that flips the lifted page to the opposite side;
a lifting mechanism that lifts an individual page with an adhesive head and utilizes a peeling action to separate the adhesive head from the lifted page.

9. The apparatus of claim 8 wherein the adhesive head utilizes a renewable and reusable adhesive.

10. The apparatus of claim 8 wherein both the lifting mechanism and the shifting mechanism are bi-directional such that pages can turn in both the forward direction and the backward direction.

11. The apparatus of claim 8 wherein the position of the lifting mechanism is adjustable to accommodate various book heights.

12. The apparatus of claim 1 wherein the lifting mechanism utilizes a clutch to control the force applied by the adhesive head to the page.

13. The apparatus of claim 8 wherein a book clamping device holds the cover of the book flat on the book support.

14. The apparatus of claim 8 wherein the controller receives user input from a single switch.

15. The apparatus of claim 8 wherein the lifting mechanism utilizes a four-bar mechanism to generate the peeling action of the adhesive head.
